(19) United States
(12) Patent Application Publication
(10) Pub. No.: US 2009/0128862 A1
(43) Pub. Date: May 21, 2009

(54) AUTOMATED METHOD AND SYSTEM FOR TRANSMITTING DOCUMENTS FROM A SCANNED SOURCE BASED ON TEXTUAL DESTINATION INFORMATION IN THE DOCUMENT

(75) Inventors: MATTHEW JOHN NOLEPA, (US); Ramesh Nagarajan, Pittsford, NY (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Norwalk, CT (US)

(21) Appl. No.: 11/944,304

(22) Filed: Nov. 21, 2007

(51) Int. Cl. H04N 1/00

(52) U.S. Cl. 358/402

(57) ABSTRACT

A method for sending image data of a document containing human readable textual destination information to a designated remote destination is herein described. The method includes receiving image data and recognizing, with a processor, the textual destination information designating a remote destination in the image data. The textual destination information may include a predetermined pattern identifying an e-mail address, IP address, or telephone number, or a region to locate such. When the textual destination information is recognized, an electronic routing address is created such that a transmission module coupled to the processor may transmit the data to the remote destination. A method and system including identifying the location of textual destination information in a first scanned document to automatically identify information in a corresponding location in a second scanned document to address and transmit the second document is also disclosed.

### BACKGROUND

1. Field

The present disclosure is generally related to methods and systems for addressing scanned documents. More specifically, the present disclosure is generally related to methods and systems for identifying textual destination information within image data and transmitting the image data to a destination based on the textual destination information.

2. Background

Often, it is desirable to send a document which has been scanned to an electronic destination or address, such as via e-mail, an Internet Protocol (IP) address, or fax. For example, electronic scanning and storage of documents has facilitated the handling of large volumes of documents, such as those handled by law firms, hospitals, universities, government institutions, and the like. Typically, the documents are entered into storage systems by use of a scanner system that scans the document and converts it into electronic image data. Once the documents are scanned, the electronic destination or address information of each document must be manually entered (i.e., requiring user intervention) to send the image data for the scanned documents to their destinations (e.g., client personal computer (PC), server, fax machine, etc.). Alternatively, destination or address information must be manually written using a writing instrument on a separate sheet of paper, such as a cover sheet when sending a fax. However, the need to manually write or enter the electronic destination information for each scanned document may be cumbersome and provide undue burden for a user when dealing with heavy scanning application workflows.

Some systems have attempted to recognize destination or address information by using glyphs or barcodes. However, the use of glyphs or barcodes may require a system to utilize an information database. For example, the database may contain the glyphs and associated addresses to be recognized. Thus, the system must be able to recognize and match the glyphs or barcode with an address in the information database. Maintaining and updating such a database may also be cumbersome and time-consuming to a user.

### SUMMARY

One aspect of the disclosure provides a method for transmitting image data of a document to a remote destination, the document containing textual destination information designating the destination. The method includes receiving image data for the document and recognizing with a processor the textual destination information designating the destination in the image data. The method also includes converting the recognized textual destination information to create an electronic routing address for use by a transmission module coupled to the processor, and transmitting, with the transmission module, the image data to the remote destination designated by the textual destination based on the created electronic routing address information.

Another aspect of the disclosure provides a method for automatically identifying and transmitting image data of a scanned document. The method includes scanning a first document into image data, wherein the first document contains textual destination information designating a first destination. The method recognizes textual destination information in the image data of the first scanned document and identifies a location of the textual destination information in the image data of the first scanned document. The location of the textual destination information is then stored. Thereafter, the method includes scanning a second document into image data, wherein the second document contains textual destination information designating a second destination. Textual destination information in the image data of the second scanned document is recognized and the recognized textual destination information of the second document is converted to create an electronic routing address for use by a transmission module coupled to a processor. The method also includes transmitting, with the transmission module, the image data of the second scanned document to the remote destination designated by the textual destination based on the created electronic routing address. The location of the textual destination information in the first scanned document may be used to identify a corresponding location in the second scanned document, such that the textual destination information in the corresponding location of the second scanned document is recognized. The textual destination information may identify the destination for transmitting the image data of the second scanned document.

An aspect of the disclosure provides a system for automatically identifying and transmitting image data of a scanned document. The system includes a module for scanning a first document into image data. The first document may contain textual destination information designating a first destination. The system also includes a module for recognizing textual destination information in the image data of the first scanned document, a module for identifying a location of the textual destination information in the image data of the first scanned document, and a module for storing the location of the textual destination information. The module for scanning scans a second document into image data. The second document may also contain textual destination information designating a second destination. The module for recognizing textual destination information recognizes textual destination information in the image data of the second scanned document. The system includes a module for converting the recognized textual destination information of the second document to create an electronic routing address for use by a transmission module coupled to a processor. The transmission module transmits the image data of the second scanned document to the remote destination designated by the textual destination based on the created electronic routing address. The module for identifying the location of the textual destination information in the first scanned document is configured to identify a corresponding location in the second scanned document, and configured to recognize textual destination information in the corresponding location of the second scanned document. The textual destination information identifies the destination for transmitting the image data of the second scanned document.

Other features, and advantages will become apparent from the following detailed description, the accompanying drawings, and the appended claims.

### BRIEF DESCRIPTION OF THE DRAWINGS

FIG. 1 shows a flow diagram for a method for sending image data of a document to a remote destination in accordance with an embodiment of the present disclosure;

FIGS. 2A and 2B show a flow diagram depicting a method for automatically identifying and associating textual destination information with scanned documents in accordance with an embodiment of the present disclosure;

FIG. 3 illustrates an example of a scanned document with textual destination information that is used to identify and transmit the document in accordance with an embodiment of the present disclosure; and

FIG. 4 illustrates a block diagram of a part of a data processing system that may be used for identifying, recognizing and transmitting a scanned document based on textual destination information in accordance with an embodiment of the present disclosure.

### DETAILED DESCRIPTION OF THE PREFERRED EMBODIMENT(S)

The disclosure herein describes a system and methods of identifying an area(s) of interest in a scanned and/or input document, and, using the information identified, converts the information to create an address (e.g., a telephone number, an IP address, an e-mail address, etc.) associated with a destination (e.g., client PC, server, fax machine, etc.) for the scanned document. The information is automatically identified in the scanned document and then the document is transmitted to a designated remote destination. The term automatically is intended herein to mean that user intervention is not required.

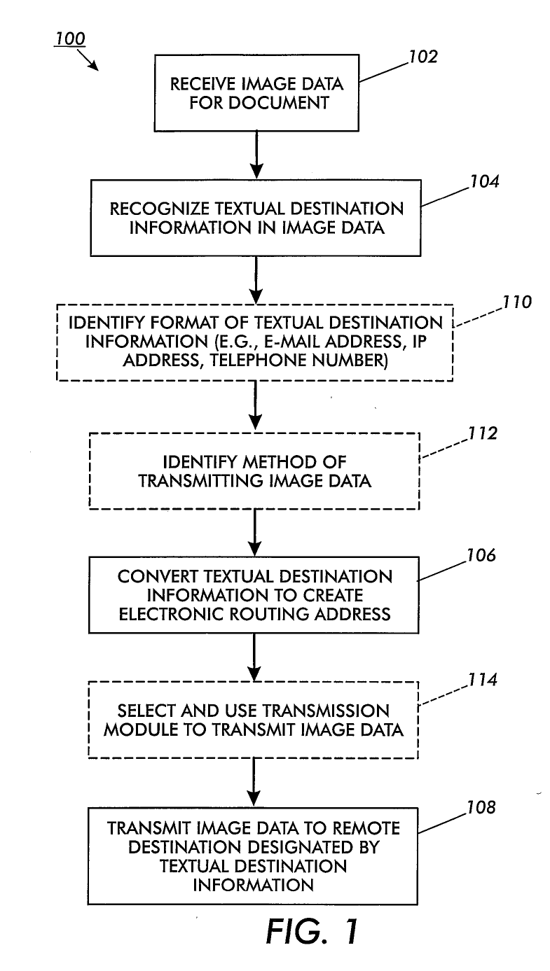

FIG. 1 shows a flow diagram for a method 100 for sending image data of a document to a remote destination in accordance with an embodiment. The method 100 comprises receiving image data for a scanned document 102 with textual destination information. The textual destination information is text in the document that identifies at least one remote destination for sending the scanned image data of the document. The term text is used to refer to written or printed words in a human readable language. Textual destination information may comprise text in a document that is unique to the document and comprises a specified format or a predetermined pattern(s). For example, formats or patterns may include an e-mail address(es) and a telephone number(s) for sending the image data thereto. Alternatively, formats or patterns may include specific text or words that identify an area(s) of interest containing destination information.

In an embodiment, the textual destination information may include manually marked text. For example, manually marked text in a scanned document may include text that is marked with a marker (such as a highlighter), text that is manually marked using a writing instrument (such as a pen), and text that is manually marked using electronic marking (such as a user interface), or a combination thereof. An example of such a method is disclosed in U.S. application Ser. No. 11/866,913 filed Oct. 3, 2007, which is hereby incorporated by reference in its entirety. The method(s) used to recognize textual destination information that is manually marked on a scanned document may include the above incorporated method as well as other methods, such as the methods described in U.S. patent application Ser. Nos. 11/414,053 and 11/476,981, filed Apr. 27, 2006 and Jun. 26, 2006, respectively, also hereby incorporated by reference in their entirety. The methods disclose the use of a two-layer multi-mask compression technology in a scanned export image path, wherein edges and text regions may be extracted, and, together with the use of mask co-ordinates and associated mask colors, the manually marked texts may be easily identified and extracted. Optical Character Recognition (OCR) and an appropriate association of the manually marked text(s) may then be used for further processing. Generally, a plurality of methods for recognizing text, either manually marked or otherwise, may be employed in the method and system as disclose herein. Further description with regard to identifying the textual destination information is provided below.

Sending the image data to the at least one remote destination may include sending the document over a communication network. For example, the network may be a digital network such as a local area network (LAN), a wide area network (WAN), the Internet or Internet Protocol (IP) network, broadband networks (e.g., PSTN with broadband technology), Voice Over IP, WiFi network, or other networks or systems, or a combination of networks and/or systems. The network may have devices or machines such as a client PC device, server, or fax device connected thereto (e.g., for receiving e-mails, documents, and faxes), for example. The remote destination may be any location physically separate from the location of the scanning device.

Referring back to FIG. 1, after image data for the scanned document 102 is received, the textual destination information in the image data is recognized 104. The textual destination information of the scanned document is then converted 106 to create an electronic routing address and the image data file for the scanned document is stored. The term electronic routing address is intended to mean herein encoded information that tells the system how the data should be routed. The encoded information may identify a location connected to a system or network capable of receiving electronic communication or allowing one to access information electronically (e.g., using a computer or client PC). For example, the address may be an IP address, e-mail address, or a telephone number. The image data of the scanned document is then transmitted 108 to the remote destination designated by the recognized textual destination information.

As noted above, the textual destination information may comprise a specified format or a predetermined pattern(s). In an embodiment, the format of the textual destination information may be identified 110. For example, formats or patterns may include an e-mail address and/or a telephone number. As an example, if the textual destination information read “name@emailaddress.com,” the image data may be recognized by the “@” symbol and/or the “.” symbol of the mail domain name, or both. Then, the format may be identified. In this case, the format is identified as an e-mail address.

In an embodiment, identifying a format and/or predetermined pattern may include identifying specific text or words that identify an area or region of interest containing destination information. For example, words such as “e-mail” or “e-mail address” may be identified. A region comprising at least one symbol associated with an e-mail address may then be recognized. For example, text containing the symbols “@” or “.” (such as an e-mail address containing a mail domain name including the extension “.com,” “.net,” or the like) may then be identified as the textual destination information.

In an embodiment, words such as “ftp,” “http,” “IP address” and the like may be identified. A region comprising a numerical string may then be recognized. For example, the numerical string may need to contain a minimum amount of numbers (e.g., ten or twelve) with a number of periods “.” (e.g., three or four) in between to be recognized as an IP address. The numerical string may then be identified as the textual destination information. In an embodiment, the textual destination information on the scanned document may be recognized by keyword searching or searching for manually marked text.

In an embodiment, words such as “fax,” “fax number,” “facsimile,” and the like may be identified. A region comprising a numerical string may then be recognized. For example, the numerical string may need to contain a minimal amount of numbers (e.g., seven or eleven) to be recognized as a telephone number. The numerical string may then be identified as the textual destination information. In an embodiment, the textual destination information on the scanned document may be recognized by keyword searching or searching for manually marked text.

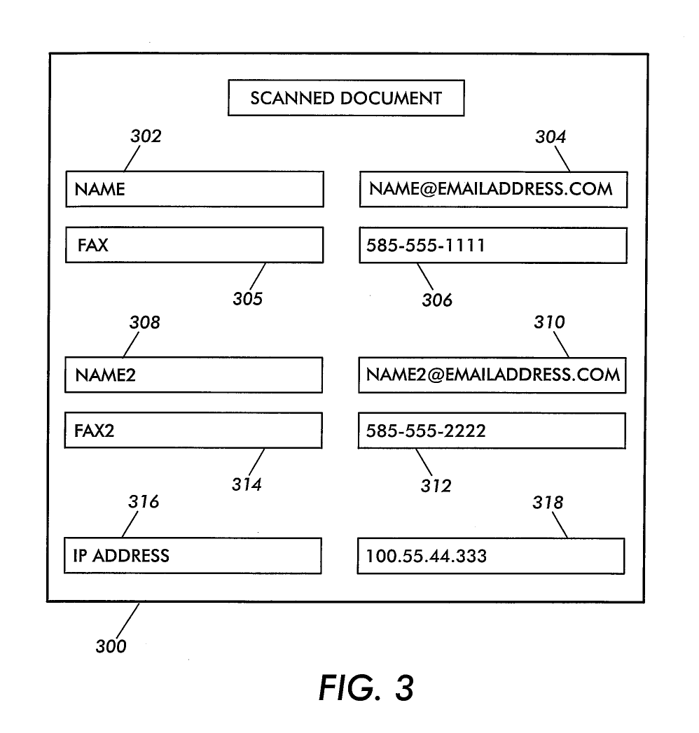

The area or region of interest containing the destination information may be an area or region that is proximal to the identified pattern, for example. An example of an area or region to be identified is further described below in FIG. 3.

In an embodiment, the system may distinguish between local, long distance, and international numbers. For example, the system may distinguish between local, long distance, and international numbers based on the number of digits that may be recognized. In an embodiment, the system may require user authentication to send image data of a scanned document. For example, in order to dial a telephone number such as a long distance or international number, the user may be request to authorize a transmission of the image data. As noted above, in an embodiment, a user may access the system electronically, such as via a client PC. In an embodiment, the user may be presented with a user interface (e.g., using an electronic device such as a client PC) which may prompt the user to authorize a transmission. In an embodiment, the system or user interface may prompt a user to enter user authentication information. For example, a user may be prompted to enter a username, password, code, and/or pin number for authentication and/or authorization. Similar authentication may be required to send e-mails and/or scanned documents over a network, for example.

The method 100 may further comprise identifying the method of transmitting the image data 112. For example, by recognizing the textual destination information or other text, the system may determine the method of transmission based on the identified format, and, thus, select and use a transmission module to transmit the image data 114. The transmission module is intended herein to include a module for transmitting image data to a remote destination designated by the textual destination based on the created electronic routing address information. In an embodiment, the method comprises selecting and using an e-mail transmission module if the identified format is an e-mail address. In an embodiment, the method comprises selecting and using an FTP or HTTP transmission module if the identified format is an IP address. In an embodiment, the method comprises selecting and using a fax transmission module if the identified format is a numerical string of a specified size or a telephone number.

In an embodiment, the method may include populating a field with the textual destination information to send the scanned document. That is, the process or method as described may be used to create an electronic routing address and to address a scanned document for transmission.

The method as generally described with reference to FIG. 1 eliminates a manual step for the user of having to access each scanned document, thus simplifying the scanning and sending process. The method also provides a uniform method of creating an electronic routing address using the original scanned document and transmitting documents to the designated destination identified by the textual destination information. The method of routing, sending, or transmitting a document using the described method decreases the amount of time required by a user (e.g., decreases the time for manually entering information for sending or for updating a database) and thus simplifies workflow.

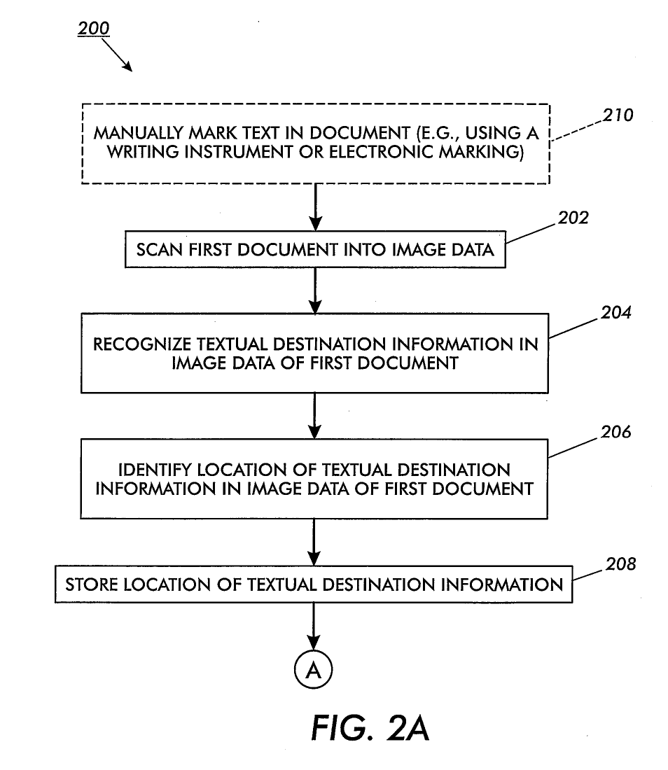

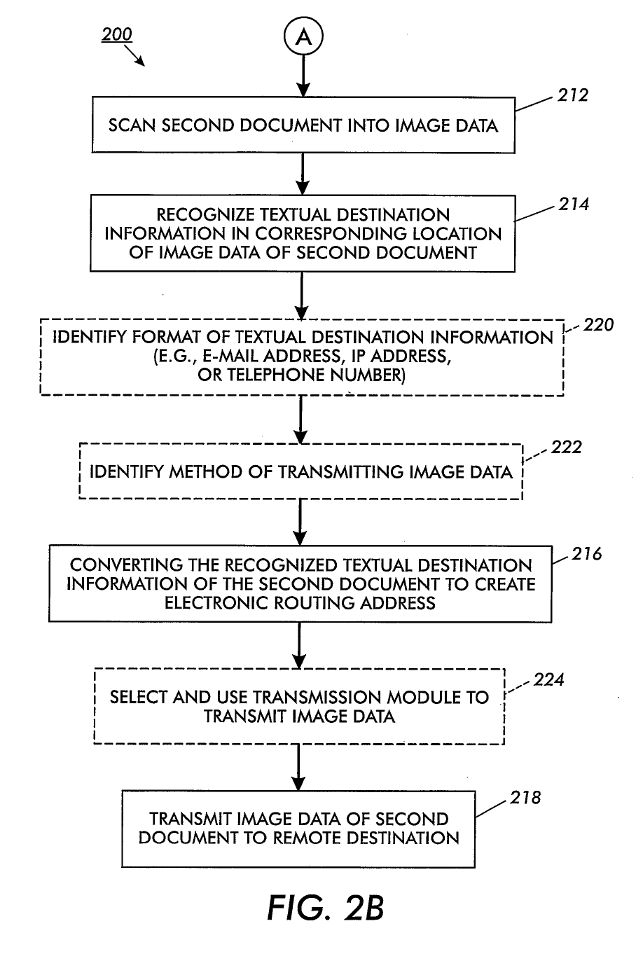

In an embodiment, the method comprises identifying the textual destination information in a predetermined location in the image data. FIGS. 2A and 2B show a flow diagram depicting a method for automatically identifying and associating textual destination information with scanned documents in accordance with an embodiment.

A first document is scanned into image data 202. In an embodiment, the textual destination information of the first document may be manually marked 210 using a writing instrument (e.g., a pen), marker (e.g., such as a highlighter), or using electronic marking, as described with reference to FIG. 1. In an embodiment, any known method for recognizing textual destination information that is selected, marked, or that comprises symbols or numerical strings of interest may be used.

The textual destination information in the first scanned document is recognized 204. After recognition 204, the location of the textual destination information in the image data of the first scanned document is identified 206. The location of the textual destination information is then stored 208.

By storing the location of the textual information of the first document, a learned behavior is developed. More specifically, as shown in FIG. 2B, when a second document is scanned into image data 212, the location of the textual destination information in the first scanned document is used to identify a corresponding location in a second scanned document, such that textual destination information in the corresponding location of the second scanned document is recognized 214. The second document does not need to be manually marked for this to occur. The method further comprises converting the recognized textual destination information of the second document to create an electronic routing address 216. The image data of the second scanned document may then be transmitted 218 to a remote destination designated by the textual destination information.

In an embodiment, after recognizing the textual destination information 214, the method may further comprise identifying the format of the textual destination information 220. As noted above, the textual destination information may comprise a specified format or a predetermined pattern(s). For example, formats or patterns may include an e-mail address and/or a telephone number. Additionally, symbols, numbers, words, or specified text may also be identified.

The method 200 may further comprise identifying the method transmitting the image data 222. For example, after determining the format of the textual destination information, the system may determine the method of transmission 222 and select and use a transmission module to transmit the image data 224. In an embodiment, the method comprises selecting and using an e-mail transmission module if the identified format is an e-mail address. In an embodiment, the method comprises selecting and using an FTP or HTTP module if the identified format is an IP address. In an embodiment, the method comprises selecting and using a fax transmission module if the identified format is a numerical string of a specified size or a telephone number.

The above described method of FIGS. 2A and 2B may be particularly beneficial for heavy scanning applications of standard forms, such as in the work place or office. The term “standard form” is intended to mean herein forms that are regularly or commonly used and/or reused. For example, law offices deal may with legal documents and/or forms, health departments may deal with insurance documents and/or forms, and accounting or banking office may deal with financial documents and/or forms. The standard forms may contain the required text (e.g., letters, numbers, or words) in a fixed location in the document. Thus, rather that a user manually accessing and inputting electronic routing addresses for each of the scanned documents of image data, the text may be used to automatically name the scanned document and/or exported file. Also, the method does not require updating of a database of glyphs or barcodes, or addresses that may be associated with such, by a user. The learned method, such as the method of FIGS. 2A and 2B, thereby simplifies a user's experience with scanned documents as the manual step of having to select each scanned document and manually enter an electronic routing address or destination for the documents to be sent to (particularly in heaving scanning applications) is eliminated.

FIG. 3 illustrates an example of a scanned document 300 with textual destination information region(s) 302-318 that is used to identify and transmit the document in accordance with an embodiment. In the example as shown in FIG. 3, the scanned document 300 generally contains image data in the form of text. As noted above, the textual destination information may include text, manually marked text or text areas or regions in a document that are identified by a format or predetermined pattern.

FIG. 3 illustrates a number of image data fields 304, 306, 310, 312, and 318 containing textual destination information within a scanned document 300. In an embodiment, the text in these fields 304, 306, 310, 312, and 318 are recognized and the textual destination information is converted to create an electronic routing address. For example, the symbol “@” of fields 304 and 310 may be recognized. Also, in an embodiment, the “@” symbol may assist in identifying the format as an e-mail address, and may identify that the method of transmission should be via e-mail (e.g., using an e-mail transmission module).

In an embodiment, image data fields 302, 305, 308, 314, and 316 (i.e., name, fax, name2, fax2, IP address) are recognized and used to identify regions that may contain textual destination information. The textual destination information in regions 304, 306, 310, 312, and 318 may be identified. For example, after recognizing the term “fax” in fields 305 and 314, the regions 306 and 312 may be identified as comprising a numerical string, and thus, converted to create an electronic routing address. Also, in an embodiment, the numerical string may assist in identifying the format as a telephone number, and may identify that the method of transmission should be via fax (e.g., using a fax transmission module). As another example, after the term “IP address” in field 316 is recognized, the region 318 may be identified as comprising a numerical string and periods “.” as noted above, and, thus, converted to create an electronic routing address to send image data.

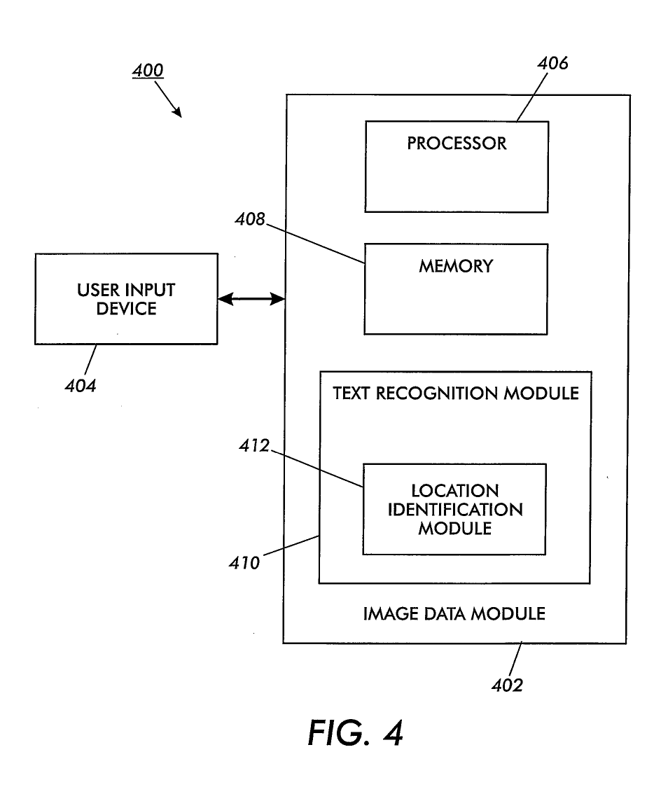

Based on the foregoing it can be appreciated that a system may be provided, based on one or more software modules as described above, which results in the identification of textual destination information in a scanned text document. FIG. 4 illustrates a block diagram of a part of a data processing system 400 that may be used for identifying, recognizing and transmitting a scanned document based on textual destination information in accordance with an embodiment of the present disclosure. Such a system 400 may be provided as, for example, an image data module 402 for converting a scanned text document (e.g., received from a scanning device or user input device 404) into image data. The scanning device or user input device 404 may comprise a device capable of scanning such as a scanner, multifunction printing device (MFP or MFD), or other known devices with scanning capabilities. Also, in an embodiment, the textual destination information may be entered by a user interacting with a user interface or input device 404. For example, a user may access a scanned document provided by a module (such as image module 402) and view such document with a display device (e.g., monitor) to use a word processing program or the like to electronically highlight or mark textual destination information or regions of textual destination information within the document. The scanned document may be scanned into image data comprising textual destination information or region associated with textual destination information, for example. The user may also specify keywords or specific text of interest that is associated with the textual destination information.

The system may also include a module 410 for optically recognizing the textual destination information in order to recognize text and/or a region comprising a numerical string or at least one symbol associated with a telephone number or e-mail address of the scanned text document. The module 410 may also convert the textual destination information to create an electronic routing address. The system may also include a processor 406; a module 412 for identifying the location of textual destination information within a document; and a memory module 408 for storing the location of the textual destination information.

In an embodiment, the system may also include a user interface module. The user interface module may provide an interface that may be used to enable a user to receive, send, and/or authenticate image data of a scanned document, for example. In some embodiments, the user interface module could enable a user to exchange information with the system via a network and an application (e.g., a browser) being executed on an electronic device such as a client PC.

Although electronic devices such as a computer and client PC may be used to provide a user interface corresponding with the system and method described herein, the type of electronic device should not be limiting. For example, it is envisioned that such an interface may be implemented on electronic devices such as a hand-held device, cell phone, personal digital assistant (PDA), etc. In addition, in an embodiment, the user interface may be a part of the machine or device such as a multifunction printing device (MFP or MFD) that includes at least the capability to scan and send such documents. Other machines and devices may also be used as long as they are capable of handling electronic image data.

The embodiments described herein may be integrated into a software architecture that aligns separate software technologies to produce a desired effect. Components from several software systems, along with textual destination information recognition module, may enable automated recognition.

The embodiments described above may also be implemented in the context of a host operating system and one or more software modules. Such may constitute hardware modules, such as, for example, electronic components of a computer system. Such modules may also constitute software modules. In the computer programming arts, a software module may be typically implemented as a collection of routines and data structures that performs particular tasks or implements a particular abstract data type.

Software modules generally include instruction media storable within a memory location of a data-processing apparatus. A software module may list the constants, data types, variable, routines, and the like that may be accessed by other modules or routines. A software module may also be configured as an implementation, which can be private (e.g., accessible perhaps only to the module), and that contains the source code that actually implements the routines or subroutines upon which the module is based. The term “module” as utilized herein may therefore refer to software modules or implementations thereof. Such modules may be utilized separately or together to form a program product that may be implemented through signal-bearing media, including transmission media and recordable media.

It is important to note that, although the embodiments are described in the context of a fully functional data-processing apparatus (e.g., a computer system), those skilled in the art will appreciate that the mechanisms of the embodiments are capable of being distributed as a program product in a variety of forms, regardless of the particular type of signal-bearing media utilized to actually carry out the distribution. Examples of signal bearing media include, but are not limited to, recordable-type media such as floppy disks or CD ROMs and transmission-type media such as analog or digital communications links.

The embodiments disclosed herein may also be executed in a variety of systems, including a variety of computers running under a number of different operating systems. The computer may be, for example, a personal computer, a network computer, a mid-range computer or a mainframe computer.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features and advantages of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A method for transmitting image data of a document to a remote destination, the document containing textual destination information designating the destination, the method comprising:
receiving image data for the document;
recognizing with a processor the textual destination information designating the destination in the image data;
converting the recognized textual destination information to create an electronic routing address for use by a transmission module coupled to the processor, and
transmitting, with the transmission module, the image data to the remote destination designated by the textual destination based on the created electronic routing address information.

2. A method according to claim 1, wherein the textual destination information is human-readable.

3. A method according to claim 2, further comprising:
identifying a format of the human-readable textual designation information in the image data.

4. A method according to claim 3, wherein the format of the textual designation information identifies a method of transmitting the image data, and wherein the method further comprises:
selecting and using a transmission module configured to transmit the image data in accordance with the identified method.

5. A method according to claim 4, wherein the format comprises a predetermined pattern identifying an e-mail address, IP address, or a telephone number; and wherein the selecting and using a transmission module includes selecting and using an e-mail transmission module if the identified format is an e-mail address, an FTP or HTTP module of the identified format is an IP address, and a fax transmission module if the identified format is a telephone number.

6. A method according to claim 5, wherein the predetermined pattern identifies a region comprising a numerical string or at least one symbol associated with an e-mail address, IP address, or telephone number.

7. A method according to claim 1, further comprising:
identifying the textual destination information in a predetermined location in the image data.

8. A method for automatically identifying and transmitting image data of a scanned document, the method comprising:
scanning a first document into image data, the first document containing textual destination information designating a first destination;
recognizing textual destination information in the image data of the first scanned document;
identifying a location of the textual destination information in the image data of the first scanned document;
storing the location of the textual destination information, and, thereafter:
scanning a second document into image data, the second document containing textual destination information designating a second destination;
recognizing textual destination information in the image data of the second scanned document;
converting the recognized textual destination information of the second document to create an electronic routing address for use by a transmission module coupled to a processor; and
transmitting, with the transmission module, the image data of the second scanned document to the remote destination designated by the textual destination information based on the created electronic routing address,
wherein the location of the textual destination information in the first scanned document is used to identify a corresponding location in the second scanned document, such that the textual destination information in the corresponding location of the second scanned document is recognized, and wherein the textual destination information identifies the destination for transmitting the image data of the second scanned document.

9. A method according to claim 8, further comprising recognizing manually marked text in the image data of the first scanned document, and wherein the manually marked text includes the textual destination information.

10. A method according to claim 8, wherein the textual destination information is human-readable.

11. A method according to claim 10, further comprising:
identifying a format of the textual destination information in the image data.

12. A method according to claim 11, wherein the format of the textual destination information identifies a method of transmitting the image data, and wherein the method further comprises:
selecting and using a transmission module configured to transmit the image data in accordance with the identified method.

13. A method according to claim 12, wherein the format comprises a predetermined pattern identifying an e-mail address, IP address, or a telephone number; and wherein the selecting and using a transmission module includes selecting and using an e-mail transmission module if the identified format is an e-mail address, an FTP or HTTP module if the identified format is an IP address, and a fax transmission module if the identified format is a telephone number.

14. A method according to claim 13, wherein the predetermined pattern identifies a region comprising a numerical string or at least one symbol associated with an e-mail address, IP address, or telephone number.

15. A method according to claim 8, further comprising:
identifying the textual destination information in a predetermined location in the image data.

16. A system for transmitting image data of a document to a remote destination, the system comprising:
a scanner for scanning a first document into image data, the first document containing textual destination information designating a first destination;
a processor for recognizing the textual destination information in the image data of the first scanned document;
a module for converting the recognized textual destination information to create an electronic routing address;
a transmission module, coupled to the processor, for transmitting the image data to the remote destination designated by the textual destination based on the created electronic routing address information.

17. A system according to claim 16, further comprising:
a module for identifying a location of the textual destination information in teh image data of the first scanned document, and
a memory for storing the location of the textual destination information.

18. A system according to claim 17, further comprising:
the scanner scanning a second document into image data, the second document containing textual destination information designating a second destination;
the processor recognizing textual destination information in the image data of the second scanned document;
the text recognition module converting the recognized textual destination information of the second document to create an electronic routing address;
the transmission module transmitting the image data of the second scanned document to the remote destination designated by the textual destination based on the created electronic routing address, and
wherein the module for identifying the location of the textual destination information in the first scanned document is configured to identify a corresponding location in the second scanned document and configured to recognize textual destination information in the corresponding location of the second scanned document, and wherein the textual destination information identifies the destination for transmitting the image data of the second scanned document.

19. A system according to claim 16, wherein the textual destination information includes human-readable text in a specified format, the format comprising a predetermined pattern including an e-mail address, IP address, or a telephone number; and
wherein the transmission module includes using an e-mail transmission module if the identified format is an e-mail address, an FTP or HTTP module if the identified format is an IP address, and a fax transmission module if the identified format is a telephone number.

20. A system according to claim 16, wherein the textual destination information includes a region comprising a numerical string or at least one symbol associated with an e-mail address, IP address, or telephone number.
